(19) United States
(12) Patent Application Publication
(10) Pub. No.: US 2009/0108067 A1
(43) Pub. Date: Apr. 30, 2009

(54) Methods and Apparatus for Managing Bar Code Scanner Configuration and Data

(75) Inventor: John Peter Roquemore, Lawrenceville, GA (US)

Correspondence Address: PAUL W. MARTIN, NCR CORPORATION, LAW DEPT., 1700 S. PATTERSON BLVD., DAYTON, OH, 45479-0001, US

(73) Assignee: NCR Corporation, Dayton, OH (US)

(21) Appl. No.: 11/930,308

(22) Filed: Oct. 31, 2007

(51) Int. Cl. G06K 7/10; G06F 17/00

(52) U.S. Cl. 235/462.15; 365/189.17

(57) ABSTRACT

Systems and techniques for bar code scanner management and communication. A bar code scanner is equipped to support the use of universal serial bus (USB) devices as clients. The scanner controls and communicates with external devices. For example, a removable storage device, such as a universal serial bus (USB) drive is loaded with instructions to be recognized and executed by the scanner upon connection of the storage device to a scanner USB port. The instructions may be prepared at a workstation presenting applications for constructing elements for performing various operations, such as updating configuration settings, upgrading scanner firmware, diagnostics, and data collection. A set of instructions, which may take the form of a disk image, for performing specified operations is prepared and transferred to the removable device, or created directly on the device. Upon connection of the device to a scanner, the scanner reads and executes the instructions.

### FIELD OF THE INVENTION

The present invention relates generally to improvements to management of bar code scanners. More particularly, the invention relates to improved systems and techniques for use of a bar code scanner configured to support the use of external devices as clients of the scanner, including the use of a portable data storage device as a client of a scanner, with the portable storage device having been be preprogrammed to communicate data and settings to, and receive data from, a bar code scanner.

### BACKGROUND OF THE INVENTION

Bar code scanners are heavily used in retail operations, and scanners continue to grow more and more sophisticated and versatile. Scanners can be configured to operate in numerous different ways, and to store and communicate data to other devices, for example, compiling operational or diagnostic data and delivering this data to a device such as a diagnostic terminal. Many retail locations and other operations, such as warehouse operations and any other operation using bar code scanning to manage transactions or to track items, employ large numbers of scanners.

### SUMMARY OF THE INVENTION

Among its several aspects, the present invention recognizes that many scanners need to be configured in the same way or to perform the same operations, or operations from a similar set of related operations. Individually configuring each scanner, or performing diagnostics or data collection on each scanner, requires labor that can be saved if mechanisms can be found to automate or partially automate the process of delivering configurations and data, and collecting data. The present invention addresses such problems, as well as others, by constructing a scanner so as to implement universal serial bus (USB) host thereby providing the scanner with the ability to accept external USB devices as clients. In one embodiment, a portable storage device, such as a universal serial bus (USB) drive, may be programmed as desired and then may be connected to a USB port of a scanner implementing USB host, and on which operations are to be performed. The USB drive may be then used as a client device for the scanner.

In preparation for use with a scanner, the USB drive can be plugged into a USB port of a terminal and programmed using the terminal. The USB drive is then removed from the terminal and plugged into a USB port of a scanner designed to recognize USB devices as clients. The scanner recognizes the USB device and uses the programming and data stored in the USB device to control the operations of the scanner. Operation of the scanner may include updating configuration settings, upgrading firmware to new firmware stored in the USB drive, delivering diagnostic or operational history information, or any of numerous other operations.

Other embodiments may include the connection of a remote interface device, such as a wireless network interface, to the scanner. In such a configuration, updated information may be transferred to a scanner from a network host through remote communication.

A more complete understanding of the present invention, as well as further features and advantages of the invention, will be apparent from the following Detailed Description and the accompanying drawings.

### BRIEF DESCRIPTION OF THE DRAWINGS

FIG. 1 illustrates a checkout system employing a scanner and scanner maintenance facilities according to an aspect of the present invention;

FIG. 2 illustrates selected details of a workstation, removable drive and scanner according to an aspect of the present invention; and

FIG. 3 illustrates a process of scanner maintenance according to an aspect of the present invention

### DETAILED DESCRIPTION

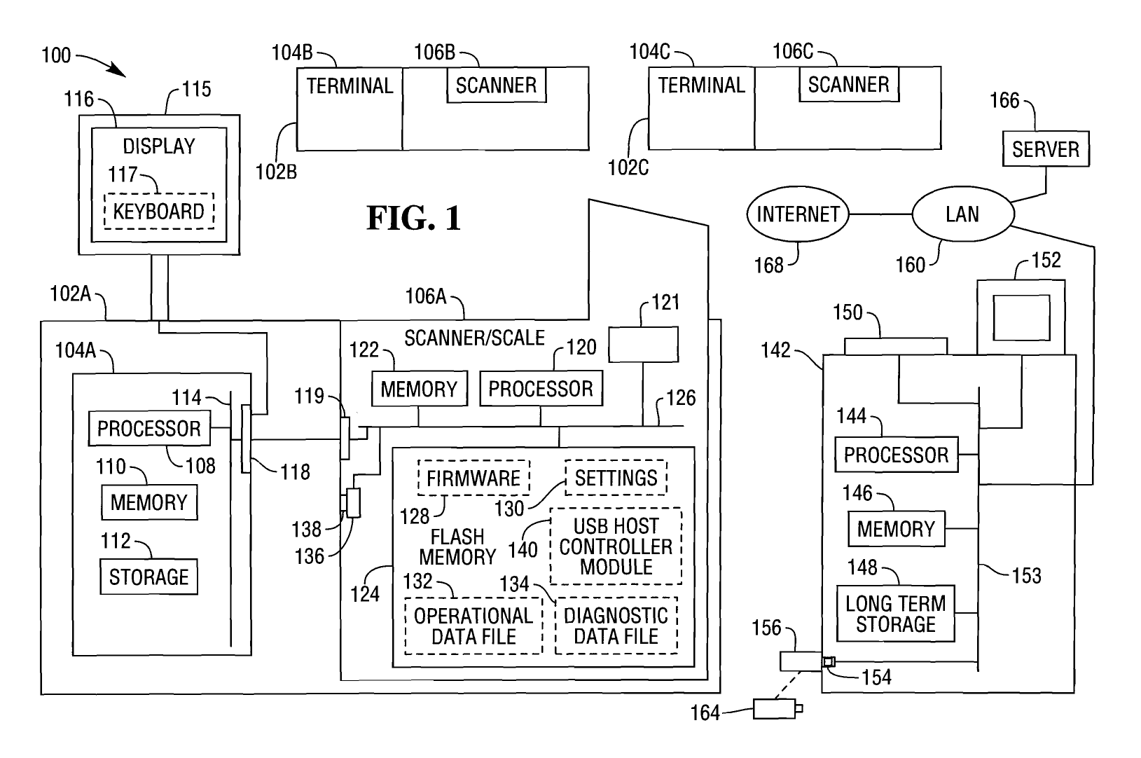

FIG. 1 illustrates a checkout system 100 according to an aspect of the present invention. The system 100 includes a plurality of checkout stations, such as the stations 102A-102C, employing terminals 104A-104C and bar code scanners 106A-106C. For the sake of simplicity, only the checkout station 102A is described in detail here, but the stations 102B and 102C may suitably be similar. In addition, it will be recognized that while only three checkout stations are illustrated here for simplicity, a typical installation may suitably include many more checkout stations, terminals, and scanners.

The station 102A includes the terminal 104A and the bar code scanner 106A. The terminal 104A includes a processor 108, high speed memory 110, and long term storage such as a hard disk 112, suitably communicating over a bus 114. The terminal 104A suitably includes a user interface 115, suitably comprising a display 116, which may be a touch screen display including a keyboard 117. The terminal 104A also includes a connection port 118 for connection to peripheral devices, such as the scanner 106A. The port 118 may suitably be a universal serial bus (USB) port, for establishing a connection to a compatible port 119 on the scanner 106A. The port 118 is suitably a USB A port, typically provided for host devices, while the port 119 may suitably be a USB B port for connection of the scanner 106A as a client device. The scanner 106A suitably includes a processor 120, high speed memory 122, and long term storage such as flash memory 124, communicating over a bus 126. The scanner 106A also suitably includes bar code information capture elements 127, such as elements for generating a scan pattern and receiving, directing, and processing light scattered light returning to the scanner 106A, in order to produce a scan signal that can be processed to extract bar code information, or image capture elements for capturing a bar code image for processing in order to extract bar code information. The flash memory 124 stores programming and settings, such as scanner firmware 128 and settings 130, and provides storage space for data, such as an operational data file 132, and diagnostic data file 134. The operational data file 132 and diagnostic data file 134 provide space for data generated during operations and diagnostics, which can be periodically transferred to a receiving unit, such as a workstation, for examination.

The scanner 106A is capable of serving as a USB host to a compatible USB device, and therefore includes a USB host controller 136 supporting a USB port 138 for connection of client devices to the scanner 106A. The port 138 is suitably a USB A port. The scanner 106A may store a USB host controller software module 140, suitably in the flash memory 124. Alternatively the USB control software may be incorporated into the scanner firmware 128. The use of a USB host controller 136 and a host controller software module 140 allows the scanner 106A to recognize and use numerous different devices as clients. One particularly advantageous use is of a USB storage device, such as a USB drive, which may be programmed with data or instructions that can be used by scanners such as the scanner 106A.

The system 100 also includes a workstation 142. The workstation 142 may serve as a scanner management station, as well as serving other functions. The workstation 142 suitably includes a processor 144, high speed memory 146, and long term storage such as a hard disk 148, as well as a display 150 and keyboard 152, communicating over a bus 153.

The workstation 142 includes one or more USB ports such as the port 154, which is suitably a USB A port. The port 154 can provide a connection to a scanner such as the scanner 106A, but the port 154 can also be used to accommodate a portable storage medium, such as a USB drive 156. The USB drive 156 can receive appropriate programming from the workstation 142, and then be connected to the scanner 106A, or another scanner, for example, by inserting the USB drive 156 in the port 138, allowing the USB drive 156 to be recognized by the scanner as a client. can then be removed and inserted into an appropriate port in a scanner, such as the port 119 of the scanner 106A. The USB drive 156 is then recognized by the scanner as a client, and the scanner operates as directed by programming stored on the USB drive 156.

In the example illustrated here, the USB drive 156 is shown as being used to provide data to and collect data from scanners used in a checkout system 100, with the scanners 106A, 106B, and 106C being deployed in the same geographic location as the workstation 142. However, it will be recognized that a workstation such as the workstation 142 can be used to store data and programming on storage devices similar to the USB drive 156, and such storage devices can be used with appropriate scanners, wherever those scanners may be located. For example, a maintenance technician might program a USB drive such as the USB drive 156, and then travel to a customer location, using the storage device to program or upgrade scanners deployed at that location, to collect data from scanners at that location, or both. To take another example, a storage device such as the USB drive 156 could be programmed with appropriate scanner configuration settings, including settings specified by a customer, such as specific light patterns or sounds, and then shipped to the customer location. The customer could then use the storage device to program scanners at the customer location.

In addition or as an alternative to the use of a USB drive such as the drive 156, the workstation 142 may suitably communicate with a local area network 160, which may provide wired or wireless network communication or a combination thereof. A USB network interface device 164, which is suitably a wireless network interface device, may be substituted for the USB drive 156, and the scanner 106A may employ the interface device 164 to communicate with the workstation 142 or similar workstations over the network 160. Alternatively or in addition, the network 160 may host a server 166, which may serve as a repository for data to be communicated between the workstation 142 and similar workstations and scanners such as the scanner 106A. The network 160 may provide access to a public network such as the Internet 168, and scanners similar to the scanner 106A, but at remote locations, may communicate with the workstation 142 and the server 166 through their own network interfaces devices. The implementation of the USB host controller 136 by the scanner 106A and similar scanners allows for the use of numerous alternative mechanisms for information transfer and control, such data transfer using the USB drive 156, network communication using the USB network interface 164, and numerous other alternatives.

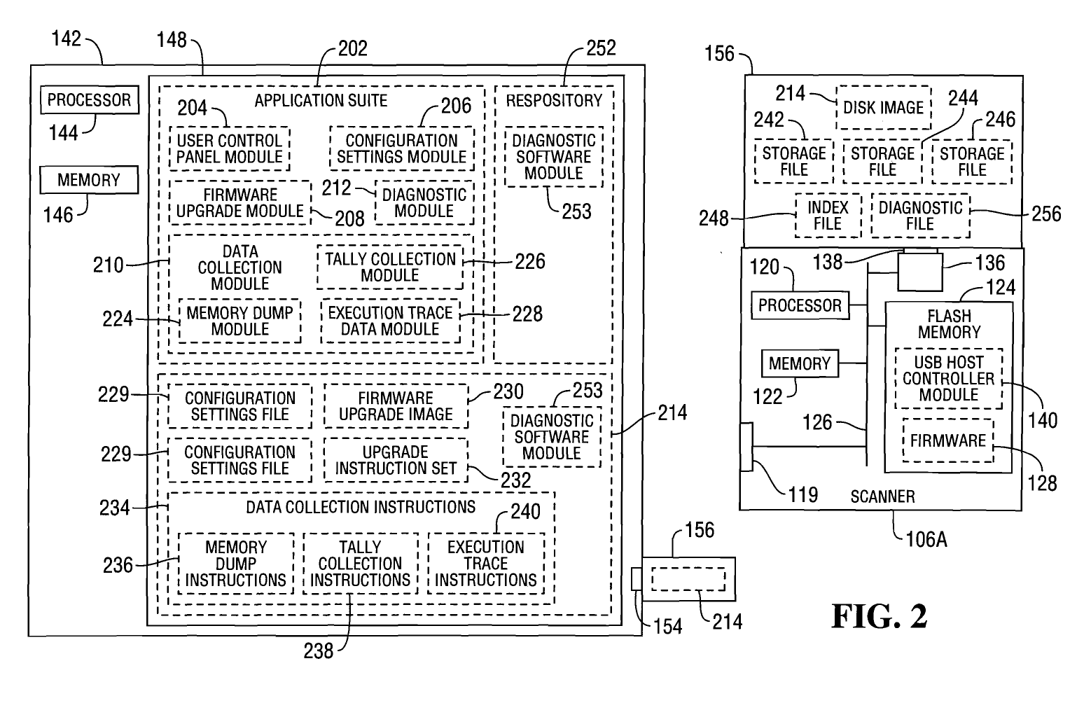

FIG. 2 illustrates additional details of the workstation 142, showing the processor 142, memory 144, and long term storage 148, with the long term storage 148 hosting programming elements used to load programming and information into a USB drive such as the USB drive 156. FIG. 2 also illustrates additional details of the scanner 106A, showing the processor 120, memory 122, flash memory 124, bus 126, firmware 128, and USB host controller module, as well as the ports 119 and 138.

The long term storage 148 of the workstation 142 hosts an application suite 202, comprising various elements that can reside on the hard disk 148 and can be transferred as needed to the high speed memory 146 for execution by the processor 144.

The application suite 202 includes a user control panel module 204, a configuration settings module 206, a firmware upgrade module 208, a data collection module 210, and a diagnostic module 212. Using the application suite 202, the user creates an appropriate image 214. The image 214 is illustrated in FIG. 2 and described below as being created on the long term storage 148 and transferred to the USB drive 156, but the image 214 can easily be created directly on the USB drive 156. In addition, the application suite 202 may reside on the USB drive 156, with the USB drive 156 serving as a storage device for the workstation 142, and the workstation 142 transferring needed elements of the application suite 202 from the USB drive 156 to the memory 146 for execution. Using this arrangement, any suitable computing device can be used as a workstation for programming the USB drive 156 or a suitable USB drive.

The image 214 may be a self executing software routine that recognizes connection to a scanner such as the scanner 106A, issues commands to the scanner 106A, and directs the receiving and storing of responses from the scanner. The specific contents of the image 214 are specified using the various components of the application suite 202.

When a user initiates the application suite 202, the application suite 202 invokes the user control panel module 204, providing a menu to the user in order to allow user selection of the operation to be performed, for example, choosing configuration settings, performing a firmware upgrade, collecting data from a scanner, performing a specific diagnostic operation or set of diagnostic operations on a scanner, or any other operation that the application suite 202 may be desired to provide. The user may first select the scanner model on which operations are to be performed and is then presented with a menu allowing selection of the operation or operations to be performed. Upon selecting an operation, an appropriate one of the modules 206, 208, 210, and 212 is opened. One or more of the modules 206-212 may include sub modules, directed toward a more specific aspect of the general operation. For example, the data collection module 210 may suitably include a memory dump module 224, a tally collection module 226, or an execution trace data collection module 228.

The selected module presents an appropriate interface to the user. For example, the configuration module 206 presents an interface allowing selection of configuration options and entry of configuration settings. The user makes the desired selections and chooses to perform a configuration operation. An appropriate disk image is created and stored as the image 214, including a configuration settings file 229. The image 214 may be created on the long term storage 148 and copied to the USB drive 156, or else may be created directly on the USB drive 156. The USB drive 156 may be connected to the scanner 106A using the port 138. Upon connection, the USB host controller 136 recognizes the presence of the USB drive 156 and interrogates the USB drive 156 under the control of the USB host module 140. The USB lost module 140 detects the programming stored on the USB drive 156 and causes execution by the processor 120 of the programming stored in the disk image 214. The stored programming directs the installation of new configuration settings. The USB drive 156 can be programmed once at the workstation 142 or a similar workstation, and taken from one scanner to another to install configuration settings with a minimum of human intervention.

In order to perform an upgrade of scanner firmware, a user selects the firmware upgrade module 208. The module 208 provides an interface, suitably allowing identification of the scanner model for which an upgrade is to be performed, selection of a specific upgrade image, or any method of selection that may be desired. If the image is not locally resident on the workstation 142, the module 208 may be designed so that the appropriate image is retrieved from a remote server. The module 208 creates an appropriate image 214, including a firmware upgrade image 230, along with an appropriate upgrade instruction set 232 to cause a scanner to retrieve and load the firmware upgrade image 230. When desired, the image 214 may be transferred onto the USB drive 156, which may then be connected to the scanner 106A, or any scanner for which firmware needs to be upgraded. The scanner 106A then responds to the instruction set 232 and loads the firmware upgrade image 230, creating new firmware 130 stored in flash memory of the scanner 106A.

The application suite 202 may also be used to collect data from a scanner, such as performing a memory dump, collecting and resetting, or collecting an execution trace. This data provides insight into the operations of a scanner. For example, a memory dump can be examined to provide diagnostic information, an execution trace can yield diagnostic and operational information by allowing examination of the various process steps and transitions undertaken during scanner operation. Tally collection provides operational statistics, for example, indicating the number of scans made. In order to set up a data collection operation, a user may select the data collection module 210 from the menu. The data collection module 210 suitably provides a submenu, allowing for selection of one or more of a memory dump operation, a tally collection operation, or an execution trace operation. Once a selection has been made, the user may choose to execute the selected operations. The data collection nodule 210 then invokes one or more of the memory dump module 224, the tally collection module 226, and the execution trace collection module 228, depending on the user selections. The data collection module 220, using the selected ones of the modules 224, 226, and 228, prepares a disk image 214, including a set 234 of data collection instructions, the set 234 including one or more of memory dump instructions 236, tally collection instructions 238, or execution trace instructions 240. The disk image 214 may be transferred to the USB drive 156. The USB drive 156 may then be connected to the scanner 106A, which executes the instructions contained in the disk image 214.

Under the control of the disk image 214, the scanner 106A creates storage files such as the storage files 242, 244, and 246 on the USB drive 156. The storage files 242, 244, and 246 include a scanner identifier and appropriate data collected from the scanner 106A. The storage file 242 may contain memory dump data, the storage file 244 may contain tally data, and the storage file 246 may contain execution trace data. The scanner 106A also creates an appropriate index file 248 on the USB drive 156A, to allow for easy identification of data files and association of a file with a scanner for which the file was created. A single USB drive such as the USB drive 156 may contain numerous sets of files such as the files 242, 244, and 246, with a set of files being created for each scanner to which the USB drive 156 is created. In this way, the USB drive 156 may be taken from scanner to scanner and data collected from each scanner. The USB drive 156 may then be taken back to the workstation 142 and the data that has been collected from the scanners may be used and examined as desired.

In order to perform a specific diagnostic operation on a scanner such as the scanner 106A, the user selects the diagnostic module 212. The diagnostic module 212 allows selection of one or more specific diagnostic operations. Appropriate software modules are retrieved from a repository 252, which is illustrated here as residing on the workstation 142, but it will be recognized that a repository such as the repository 252 may reside on a remote server. The selected diagnostic software modules, such as the module 253, are assembled into the disk image 214 and transferred to the USB 156, and when the USB 156 is connected to the scanner 106A, the disk image 214 is executed, causing the scanner 106A to perform the appropriate diagnostic operations. Results of the operations are stored in a diagnostic file 256, which includes a scanner identification and any stored results of the diagnostic operations. The USB 156 may be returned to the workstation 142 and the diagnostic file 256 examined.

The disk image 214 may include any or all of the various elements that can be created by the application suite 202, allowing the ability to perform multiple operations on a scanner, if desired, for example, to perform a flash upgrade, load configuration settings, and collect data during the same connection of a USB drive to a scanner.

In addition to storing the disk image on a USB drive such as the USB drive 156, disk images and other information may be stored locally on the workstation 142, on a server such as the server 166 of FIG. 1, or at any other location or facility that may be made accessible to scanners such as the scanner 106. The disk image 214 may be transferred to the scanner 106A over a network connection and executed by the scanner 106A. Similarly, the disk image 214 may be updated by the scanner 106A and transferred over a network connection to the server 166, the workstation 142, or another appropriate location.

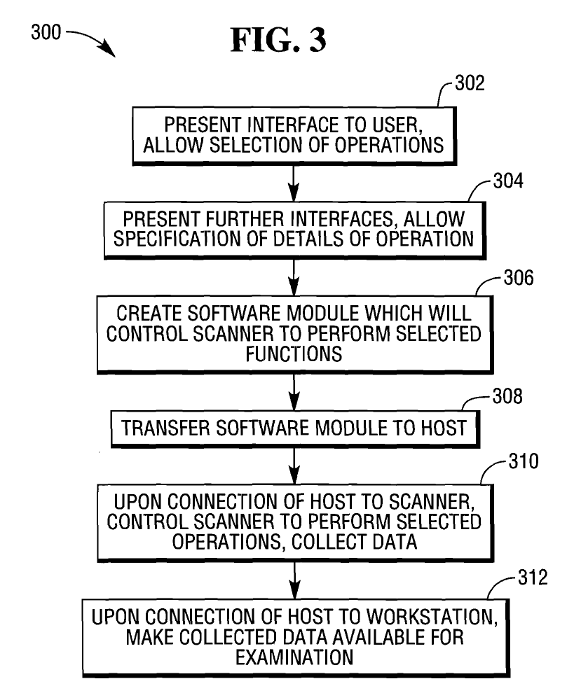

FIG. 3 illustrates the steps of a process 300 according to an aspect of the present invention. At step 302, upon invocation of an application suite for performing scanner maintenance, an interface is presented to a user, allowing the user to select operations to be performed. Operations that may be selected include, for example, setting scanner configurations, updating scanner firmware, scanner data collection, and scanner diagnostics. At step 304, upon user selection of an operation, further interfaces are presented to the user, allowing user specification of details of the operation. Steps 302 and 304 may be repeated, allowing user selection of multiple operations and specification of operational details in a single session.

At step 306, a software module, such as a disk image, is created, which, upon execution, will control a scanner so as to perform the selected functions. The software module suitably includes executable code for performing the functions, as well as stored data, such as configuration settings and firmware for installation, that will be transferred to the scanner or used to set parameters for execution of the software module. The software module may suitably be a self executing module that is automatically invoked when a device storing the software module is connected to a scanner with which the module is designed to operate. At step 308, the software module is transferred to a host, such as a removable drive, which may conveniently be a USB drive.

At step 310, upon connection of the host to a scanner, the software module controls the scanner so as to perform the selected functions and load selected data and settings. If the selected functions include capturing scanner data, data is stored in appropriate files created on the host device, with each file including an identifier for the scanner and an identifier indicating the nature of the stored data. The same host may be connected to a number of scanners, with the same functions performed and the same data captured from each. At step 312, upon connection of the host to a workstation, data captured from the scanner or scanners is made available for examination.

While the present invention is disclosed in the context of a presently preferred embodiment, it will be recognized that a wide variety of implementations may be employed by persons of ordinary skill in the art consistent with the above discussion and the claims which follow below.

I claim:

1. A bar code scanner, comprising:
a collection of elements for receiving and bar code data that can be processed to extract bar code information;
data processing elements for receiving and processing information including bar code information and information received from and to be communicated to external devices; and
communication interface elements for communicating with external devices, including a universal serial bus (USB) host controller and USB host interface allowing connection of client devices to the scanner, the client devices to be operated under control of the scanner.

2. The bar code scanner of claim 1, further comprising a storage medium storing software executable by a processor for managing external devices connected to the scanner as clients.

3. The bar code scanner of claim 2, wherein the software includes USB host control software.

4. The bar code scanner of claim 3, wherein the scanner is operative to recognize and control data an external data storage device connected to the scanner as a client.

5. The bar code scanner of claim 3, wherein the scanner is operative to recognize and control an external communication device connected to the scanner as a client.

6. The bar code scanner of claim 5, wherein the external communication device is a wireless network interface.

7. A portable memory device for controlling operations of a bar code scanner, comprising:
a connector for establishing a connection to the scanner by insertion into a port of the scanner; and
a storage medium; and
computer instructions stored on the storage medium so as to be detected and loaded by the scanner upon connection of the memory device to the scanner, the computer instructions operative to control the scanner so as to perform operations indicated by the computer instructions, the computer instructions being constructed so as to perform the same set of operations on a plurality of scanners to which the portable memory device may be connected.

8. The memory device of claim 7, wherein the connector is a universal serial bus connector adapted for insertion into a compatible universal serial port on the scanner.

9. The memory device of claim 7, further including scanner configuration settings stored on the storage medium, and wherein the computer instructions include instructions to the scanner for loading and installing the scanner configuration settings.

10. The memory device of claim 7, further including a scanner firmware installation stored on the storage medium, and wherein the computer instructions include instructions to the scanner for loading and installing the scanner firmware installation.

11. The memory device of claim 7, wherein the computer instructions include instructions for transferring selected scanner data to a designated location in the storage medium.

12. The memory device of claim 11, wherein the instructions for transferring selected scanner data include storing a scanner identifier associating the scanner data with the specific scanner that is the source of the scanner data.

13. A programming station for programming a portable memory device for automatically controlling a scanner to perform designated operations, comprising:
a connection port for accepting a portable memory device;
a storage medium for storing data and program instructions; and
a processor operating under the control of the stored program instructions, the processor being operative to create a disk image for transfer to the portable memory device, the disk image being detectable by a scanner upon connection of a memory device to the scanner and operative to control the scanner so as to perform selected operations designated upon creation of the disk image.

14. The programming station of claim 13, wherein the processor is operative to assemble scanner configuration settings for transfer to the scanner, and wherein creation of the disk image includes storing the assembled scanner configuration settings and instructions for installing the assembled configuration settings to the scanner.

15. The programming station of claim 14, wherein assembling scanner configuration settings includes retrieving scanner configuration settings for a selected scanner model from a remote location.

16. The programming station of claim 13, wherein the processor is operative to assemble scanner firmware for transfer to the scanner, and wherein creation of the disk image includes storing the assembled scanner firmware and instructions for installing the assembled firmware to the scanner.

17. The programming station of claim 16, wherein assembling scanner configuration settings includes retrieving scanner firmware for a selected scanner model from a remote location.

18. The programming station of claim 13, wherein creation of the disk image includes creation and storage of instructions for storing selected scanner data to the portable memory device.

19. The programming station of claim 13, wherein the processor is operative to retrieve stored scanner data from a portable memory device on which such data has been stored and present the stored scanner data for examination.

20. A method for performing maintenance on a bar code scanner, comprising the steps of:
presenting to a user a selection of operations to be performed on a scanner;
upon selection by the user of the operations to be performed, assembling a software module to control the scanner to perform the operations;
storing the software module onto a portable storage device;
upon connection of the portable storage device to the scanner, controlling the scanner so as to perform the selected operations.

21. The method of claim 20, wherein the operations include loading scanner configuration settings, and wherein assembling the software module includes assembling the scanner configuration settings and instructions for loading the scanner configuration settings.

22. The method of claim 20, wherein the operations include loading scanner firmware, and wherein assembling the software module includes storing scanner firmware to be loaded along with instructions for loading the scanner firmware.

23. The method of claim 20, wherein the operations include storing selected scanner data to the portable storage device, and wherein assembling the software module includes assembling instructions identifying the selected scanner data to be stored and instructions for storing the identified scanner data to the portable storage device.
